(19) United States
(12) Patent Application Publication
(10) Pub. No.: US 2018/0279373 A1
(43) Pub. Date: Sep. 27, 2018

(54) METHOD AND APPARATUS FOR PERFORMING RANDOM ACCESS PROCEDURE

(71) Applicant: LG ELECTRONICS INC., Seoul (KR)

(72) Inventors: Jaewook LEE, Seoul (KR); Youngdae LEE, Seoul (KR)

(73) Assignee: LG ELECTRONICS INC., Seoul (KR)

(21) Appl. No.: 15/758,610

(22) PCT Filed: Sep. 23, 2016
(86) PCT No.: PCT/KR2016/010703

§ 371 Date: Mar. 8, 2018

Related U.S. Application Data
(60) Provisional application No. 62/222,222, filed on Sep. 23, 2015.

(51) Int. Cl. H04W 74/08; H04W 48/14; H04W 72/04; H04W 48/16; H04W 74/00

(52) U.S. Cl. CPC H04W 74/0833; H04W 48/14; H04W 74/008; H04W 48/16; H04W 72/0413

(57) ABSTRACT

The present invention relates to a wireless communication system. More specifically, the present invention relates to a method and a device for performing random access procedure in a wireless communication system. According to an aspect of the present invention, the method comprising: determining an index of a first subband based on an identity of the UE and receiving, from the network, a first message for a contention resolution through the first subband.

### TECHNICAL FIELD

The present invention relates to wireless communications, and more particularly, to a method and apparatus for performing random access procedure.

### BACKGROUND ART

Wireless communication systems are widely developed to provide a various kinds of communication services such as audio or data service. In general, a wireless communication system is a multiple access system capable of supporting communications with multiple users by sharing available system resources (bandwidths, transmission power, etc.). Examples of the multiple access system include a CDMA (Code Division Multiple Access) system, FDMA (Frequency Division Multiple Access) system, TDMA (Time Division Multiple Access) system, OFDMA (Orthogonal Frequency Division Multiple Access) system, SC-FDMA (Single Carrier Frequency Division Multiple Access) system, MC-FDMA (Multi-Carrier Frequency Division Multiple Access) system, etc.

### DISCLOSURE OF INVENTION

### Technical Problem

Based on the above-mentioned discussion, methods for performing random access procedure and apparatuses therefor shall be proposed in the following description.

Technical tasks obtainable from the present invention are non-limited by the above-mentioned technical task. And, other unmentioned technical tasks can be clearly understood from the following description by those having ordinary skill in the technical field to which the present invention pertains.

### Solution to Problem

To achieve these and other advantages and in accordance with the purpose of the present invention, as embodied and broadly described, a method for performing random access procedure by a user equipment (UE) in a wireless communication system, the method comprising: determining an index of a first subband based on an identity of the UE; and receiving, from the network, a first message for a contention resolution through the first subband.

In accordance with another aspect of the present invention, a user equipment (UE) in a wireless communication system, the UE comprising: a radio frequency (RF) module configured to transmit/receive signals to/from a network; and a processor connected with the RF module, wherein the processor is configured to determine an index of a first subband based on an identity of the UE and control the RF module to receive, from the network, a first message for a contention resolution through the first subband.

Preferably, the index of the first subband is determined based on a value corresponding to a reminder after dividing the identity of the UE to a number of subbands within a system bandwidth.

Preferably, the number of subbands within a system bandwidth is provided in system information.

The method further comprising: transmitting, to a network, a second message including the identity of the UE before receiving the first message.

Preferably, the second message corresponds to a radio resource control (RRC) connection request message.

The method further comprising: receiving, from the network, a random access response message, including information on an uplink grant resource for transmitting the second message, through a second subband.

Preferably, the first subband and the second subband are different.

Preferably, the identity of the UE corresponds to a SAE-temporary mobile subscriber identity (S-TMSI).

Preferably, the identity of the UE corresponds to a random value generated by the UE.

Preferably, information on an available subband for determining the first subband is provided in system information.

### Advantageous Effects of Invention

According to embodiments of the present invention, a user equipment can perform random access procedure in a wireless communication system.

It will be appreciated by persons skilled in the art that the effects that can be achieved with the present invention are not limited to what has been particularly described hereinabove and other advantages of the present invention will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention. In the drawings:

FIG. 1 shows a network structure of an E-UMTS (Evolved Universal Mobile Telecommunication System);

FIG. 2 shows structures of an E-UTRAN (Evolved Universal Terrestrial Radio Access Network) and a gateway;

FIGS. 3 and 4 show user/control plane protocols with respect to an E-UMTS;

FIG. 5 shows a structure of a radio frame used in an E-UMTS;

FIG. 6 illustrates an operation performed between a UE and an eNB in a contention-based random access procedure.

FIG. 7 shows an example of a method for performing a random access procedure according to an embodiment of the present invention.

FIG. 8 is a block diagram for one example of a communication device according to one embodiment of the present invention.

### MODE FOR THE INVENTION

Configurations, operations and other characteristics of the present invention will be easily understood according to embodiments of the present invention, described with reference to the attached drawings. Though the following embodiments will describe a case in which technical characteristics of the present invention are applied to a 3GPP system, the embodiments are exemplary and the present invention is not limited thereto.

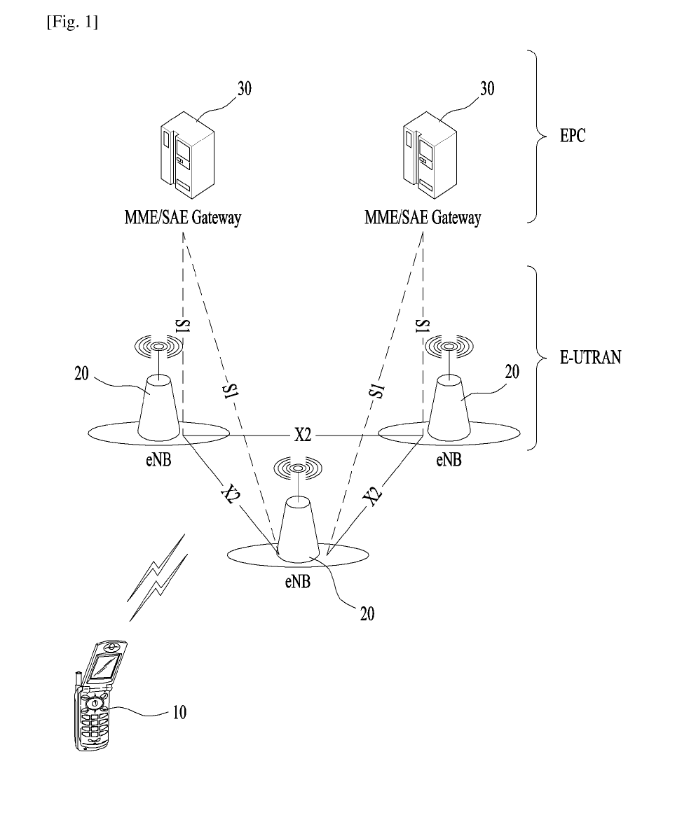

FIG. 1 shows a network structure of an E-UMTS. The E-UMTS is also referred to as a LTE system. A communication network is arranged in a wide range and provides various communication services such as audio and packet data service.

Referring to FIG. 1, an E-UMTS network includes an E-UTRAN (Evolved Universal Terrestrial Radio Access Network), an EPC (Evolved Packet Core), and one or more user equipments (UE). The E-UTRAN may include one or more base stations (eNB) 20. The one or more UEs 10 may be located in one cell. One or more E-UTRAN mobility management entity/system architecture evolution (MME/SAE) gateways 30 may be located at the end of the network and connected to an external network. In the specification, a downlink means transmission from the base station 20 to the UE 10 and an uplink means transmission from the UE 10 to the base station 20.

The UE 10 is a communication device carried by a user and may be referred to as a mobile station (MS), a user terminal (UT), a subscriber station (SS), or a radio device. Each base station 20 is a fixed station communicating with the UE 10 and may be referred to as an access point (AP). The base station 20 provides end points of a user plane and a control plane to the UE 10. One base station 20 may be located in each cell. An interface for transmitting user traffic or control traffic may be used between the base stations 20. Each MME/SAE gateway 30 provides end points of session and mobility management function to the UE 10. The base station 20 and the MME/SAE gateway 30 can be connected to each other through an S1 interface.

MME provides various functions including distribution of a paging message to the base stations 20, security control, idle state mobility control, SAE bearer control, and encryption of non-access stratum (NAS) layer signaling and integrity protection. An SAE gateway host provides various functions including completion of a plane packet and user plane switching for supporting mobility of the UE 10. The MME/SAE gateway 30 is simply referred to as a gateway in the specification. However, the MME/SAE gateway 30 includes both MME and SAE gateways.

A plurality of nodes may be connected through S1 interfaces between the gateways 30 and the base stations 20. The base stations 20 may be connected to each other through an X2 interface and neighbor base stations may have a mesh network structure with the X2 interface.

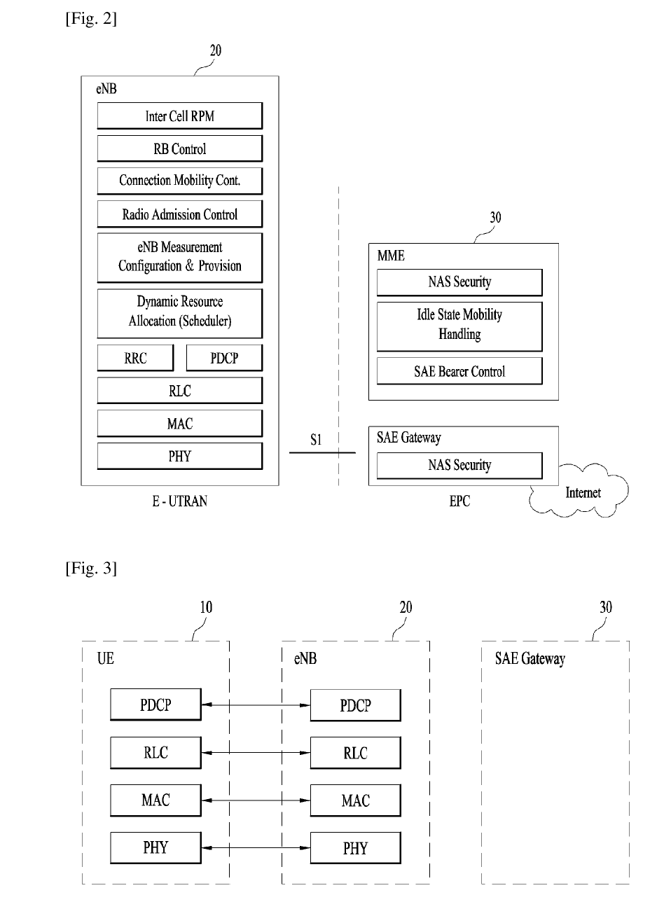

FIG. 2 shows structures of a general E-UTRAN and the general gateway 30. Referring to FIG. 2, the base station 20 can execute functions such as selection of the gateway 30, routing to the gateway during activation of radio resource control (RRC), scheduling and transmission of a paging message, scheduling and transmission of broadcast channel (BCCH) information, dynamic resource allocation for the UE 10 on both uplink and downlink, configuration and preparation of base station measurement, radio bearer control, radio admission control (RAC), and connection mobility control. The gateway 30 can perform functions such as paging transmission, LTE_IDLE state management, user plane encryption, system architecture evolution bearer control, encryption of NAS layer signaling and integrity protection.

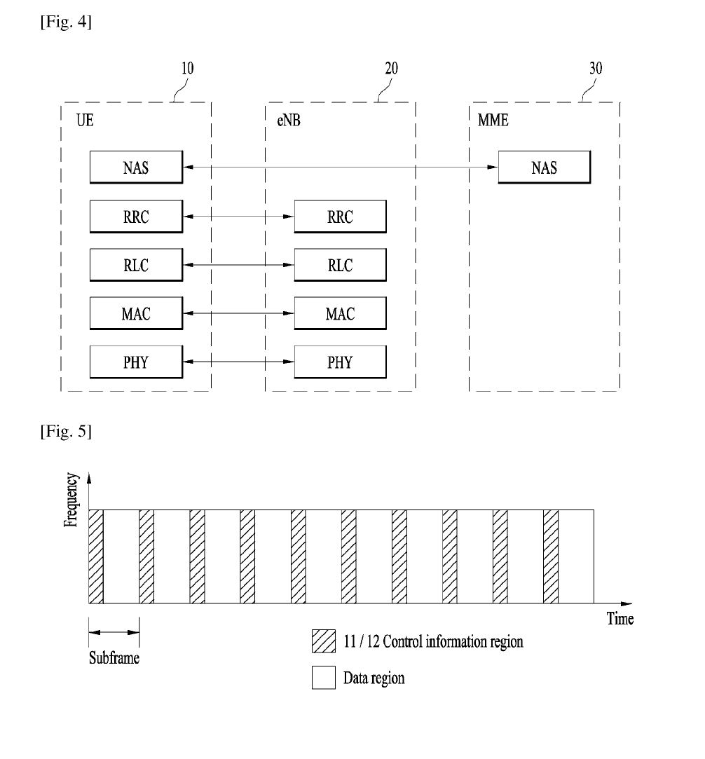

FIGS. 3 and 4 show user-plane protocol and control-plane protocol stacks for an E-UMTS. Referring to FIGS. 3 and 4, protocol layers can be divided into a first layer L1, a second layer L2, and a third layer L3 on the basis of lower three layers of the open system interconnection (OSI) standard model known in communication system technologies.

A physical layer PHY corresponding to the first layer L1 provides information transmission to an upper layer using a physical channel. The physical layer is liked to a medium access control (MAC) layer located at an upper level through a transmission channel, and data is transmitted between the physical layer and the MAC layer through the transmission channel. Data is transmitted between a physical layer of a transmitter and a physical layer of a receiver through a physical channel.

An MAC layer corresponding to the second layer L2 provides a service to a radio link control (RLC) layer corresponding to an upper layer through a logical channel. The RLC layer of the second layer L2 supports reliable data transmission. When the MAC layer performs an RLC function, the RLC layer is included in the MAC layer as a functional block. A PDCP (Packet Data Convergence Protocol) layer of the second layer L2 performs a header compression function. The header compression function efficiently transmits an Internet protocol (IO) packet such as IPv4 or IPv6 through a radio interface having a relatively narrow bandwidth.

A radio resource control (RRC) layer located at the lowest level of the third layer L3 is defined for a control plane only. The RRC layer controls a logical channel, a transmission channel and a physical channel with respect to setup, re-setup and cancellation of radio bearers (RBs). A radio bearer (RB) means a service provided by the second layer L2 for data transmission between the UE 10 and the E-UTRAN.

Referring to FIG. 3, the RLC layer and the MAC layer are finished in the base station 20 and can perform functions such as scheduling, automated retransmission request (ARQ) and hybrid automated retransmission request (HARQ). The PDCP layer is finished in the base station 20 and can execute functions such as header compression, integrity protection and encryption.

Referring to FIG. 4, the RLC layer and the MAC layer are completed in the base station 20 and perform the same function as those in the control plane. As shown in FIG. 3, the RRC layer is finished in the base station 20 and can perform functions such as broadcasting, paging, RRC connection management, radio bearer control, mobility function, and UE measurement report and control. As shown in FIG. 2(c), a NAS control protocol is finished in MME of the gateway 30 and can execute functions such as SAE bearer management, authentication, LTE_IDLE mobility handling, paging transmission in LTE_IDLE state, and security control for signaling between the gateway and the UE 10.

The NAS control protocol can use three states. A LTE-DETACHED state is used when RRC entity is not present. A LTE_IDLE state stores minimum UE information and is used when RRC connection is not present. A LTE_ACTIVE state is used when RRC state is set up. The RRC state is divided into RRC_IDLE and RRC_CONNECTED states.

In the RRC_IDLE state, the UE 10 perform discontinuous receiving (DRX) set by NAS using ID uniquely allocated thereto in a tracking region. That is, the UE 10 can receive broadcast of system information and paging information by monitoring a paging signal on a specific paging occasion for each UE-specific paging DRX cycle. In the RRC_IDLE state, no RRC context is stored in the base station.

In the RRC_CONNECTED state, the UE 10 can transmit/receive data to/from the base station using E-UTRAN RRC connection and context in E-UTRAN. Furthermore, the UE 10 can report channel quality information and feedback information to the base station. In the RRC_CONNECTED state, the E-UTRAN is aware of the cell to which the UE 10 belongs. Accordingly, the corresponding network can transmit and/or receive data to and/or from the UE 10, control mobility of the UE, such as a handover, and perform cell measurement with respect to neighboring cells.

FIG. 5 shows a structure of a radio frame used in an E-UMTS.

Referring to FIG. 5, the E-UMTS uses a radio frame of 10 ms. One radio frame includes ten subframes. One subframe has two continuous slots. The length of one slot is 0.5 ms. Furthermore, one subframe is composed of a plurality of symbols (for example, OFDM symbols, SC-FDMA symbols, etc.). One subframe is composed of a plurality of resource blocks, and one resource block includes a plurality of symbols and a plurality of subcarriers. Some (for example, a first symbol) of the plurality of symbols constituting one subframe can be used to transmit L1/L2 control information. A physical channel (for example, PDCCH (Physical Downlink Control Channel)) transmitting the L1/L2 control information is composed of subframes on the time domain and subcarriers on the frequency domain.

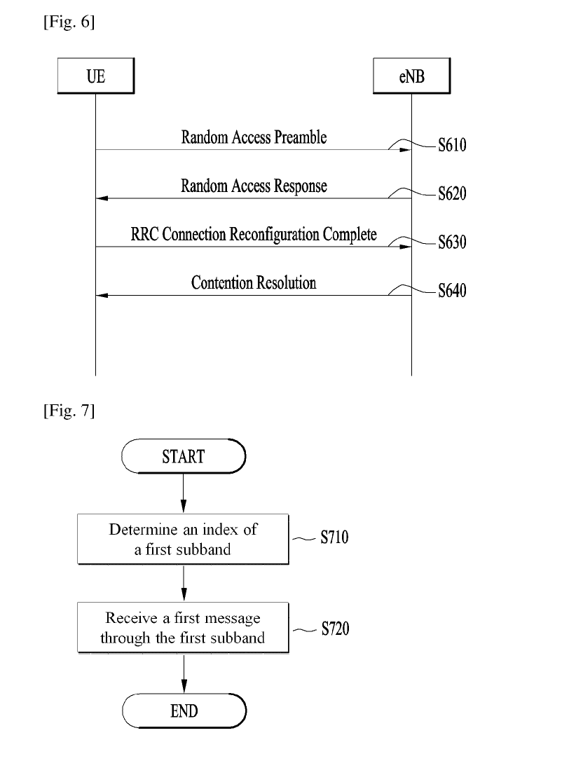

FIG. 6 illustrates an operation performed between a UE and an eNB in a contention-based random access procedure.

(1) Transmission of First Message (Msg1)

The UE may randomly select a Random Access Preamble from a set of Random Access Preambles indicated by system information or a Handover Command message, select Physical RACH (PRACH) resources, and transmit the selected Random Access Preamble in the PRACH resources to the eNB (S610).

(2) Reception of Second Message (Msg2)

After transmitting the random access preamble in step S610, the UE attempts to receive a Random Access Response (RAR) message within a random access response reception window indicated by the system information or the Handover Command message from the eNB (S620).

The RAR message may be transmitted in a Medium Access Control (MAC) Packet Data Unit (PDU) and the MAC PDU may be transmitted on a PDSCH in step S620. To receive information on the PDSCH successfully, the UE preferably monitors a Physical Downlink Control Channel (PDCCH).

The PDCCH may deliver information about a UE to receive the PDSCH, time and frequency information about radio resources of the PDSCH as resource allocation information, and information about the transport format of the PDSCH. Once the UE successfully receives the PDCCH directed to it, the UE may appropriately receive an RAR on the PDSCH based on information of the PDCCH. The RAR may include a Random Access Preamble Identifier (RAPID), an UpLink (UL) Grant indicating UL radio resources, a Temporary Cell-Radio Network Temporary Identifier (C-RNTI), and a Timing Advance Command (TAC).

The reason for including the RAPID in the RAR is that one RAR may include RAR information for one or more UEs and thus it is necessary to indicate a UE for which the UL Grant, the Temporary C-RNTI, and the TAC are valid. Herein, it is assumed that the UE selects an RAPID matching the Random Access Preamble selected by the UE.

(3) Transmission of Third Message (Msg 3)

If the UE receives an RAR message valid for it, the UE processes information included in the RAR message. That is, the UE applies a RAC and stores the Temporary C-RNTI. In addition, the UE may store data to be transmitted in response to the valid RAR reception in an Msg 3 buffer.

Meanwhile, the UE transmits data (i.e. a third message) to the eNB based on the received UL Grant. That is, the UE transmits a third message in UL resources allocated by the UL Grant to the eNB (S630).

The third message should include an ID of the UE. In the contention-based random access procedure, the eNB may not determine which UE is performing the random access procedure and should identify the UE to resolve collision later. The third message may be an RRC Connection Request message or an RRC Connection Reconfiguration Complete message.

(4) Reception of Fourth Message

After transmitting the data including its ID based on the UL Grant included in the RAR, the UE receives a Contention Resolution message on a DL-SCH from the eNB (S640).

As an embodiment of the present invention, the UE may receive the Contention Resolution message from the eNB through a subband determined based on the ID of the UE. In this case, the subband for the Contention Resolution message may be different from a subband for the Random Access Response (RAR) message. Detailed description thereof will be described below with reference to FIG. 7.

From the perspective of the physical layer, a Layer 1 (L1) random access procedure refers to transmission and reception of a Random Access Preamble and an RAR message in steps S610 and S620. The other messages are transmitted on a shared data channel by a higher layer, which is not considered to fall into the L1 random access procedure.

In the above RACH procedure, an RACH includes 6 RBs in one or more contiguous subframes reserved for transmission of a Random Access Preamble. The L1 random access procedure is triggered by a preamble transmission request from a higher layer. A preamble index, a target preamble reception power PREAMBLE_RECEIVED_TARGET_POWER, a matching RA_RNTI, and PRACH resources are part of the preamble transmission request, indicated by the higher layer.

A preamble sequence is selected from a preamble sequence set, using a preamble index. A single preamble is transmitted in PRACH resources indicated by the transmission power PPRACH using the selected preamble sequence.

Detection of a PDCCH indicated by the RA-RNTI is attempted within a window controlled by the higher layer. If the PDCCH is detected, a corresponding DL-SCH transport block is transmitted to the higher layer. The higher layer analyzes the transport block and indicates a 20-bit UL Grant.

Some MTC UEs are installed in the basements of residential buildings or locations shielded by foil-backed insulation, metalized windows or traditional thick-walled building construction, and these UEs would experience significantly greater penetration losses on the radio interface than normal LTE devices. The MTC UEs in the extreme coverage scenario might have characteristics such as very low data rate, greater delay tolerance, and no mobility, and therefore some messages/channels may not be required.

Coverage enhancement for low-cost MTC UEs is described. It may be referred to Section 9 of 3GPP TR 36.888 V12.0.0 (2013-06). Performance evaluation of coverage enhancement techniques may be analyzed in terms of coverage, power consumption, cell spectral efficiency, specification impacts and, cost or complexity analysis. Not all UEs will require coverage enhancement, or require it to the same amount. It may be possible to enable the techniques only for the UEs that need it.

For coverage analysis, an additional coverage requirement of a 20 dB enhancement in comparison to “category 1 UEs” is targeted. Table 1 shows a minimum couple loss (MCL) table for category 1 UEs.

TABLE 1

| Physical | | | | | | | |
|---|---|---|---|---|---|---|---|
| channel | PUCCH | | | | | | PDCCH |
| name | (1A) | PRACH | PUSCH | PDSCH | PBCH | SCH | (1A) |
| MCL | 147.2 | 141.7 | 140.7 | 145.4 | 149.0 | 149.3 | 146.1 |
| (FDD) | | | | | | | |
| MCL | 149.4 | 146.7 | 147.4 | 148.1 | 149.0 | 149.3 | 146.9 |
| (TDD) | | | | | | | |

Referring to Table 1, it can be expected when the amount of coverage enhancement becomes larger, all channels listed in Table 1 need to be improved. For example, if the amount equals 20 dB, all uplink and downlink channels need to be enhanced because the gap between maximum MCL and minimum MCL is 8.6 dB for FDD and 2.7 dB for TDD. Given that single receive radio frequency (RF) and bandwidth reduction may be used for MTC UEs, and these techniques would decrease downlink coverage, additional coverage enhancement needs to be considered to compensate this coverage loss.

Assuming an x dB coverage enhancement is desired, the limiting channel from Table 1 with the minimum MCL will need to be improved by x dB. Note that x dB coverage enhancement is with respect to category 1 UE at the data rate of 20 kbps. The other channels will require less enhancement, with the overall amount of compensation equal to x dB reduced by the difference between the MCL and the minimum MCL. The overall amount of compensation should also include the application of low-cost MTC techniques: single receive RF chain would require additional coverage compensation for all downlink channels, and reduction of maximum bandwidth may require additional coverage compensation for the (E)PDCCH and physical downlink shared channel (PDSCH).

Required system functionality for MTC UEs in coverage enhancement mode is assumed to include functionality needed for synchronization, cell search, power control, random access procedure, channel estimation, measurement reporting and DL/UL data transmission (including DL/UL resource allocation). A MTC user who moves around is unlikely to be out of coverage for long. Accordingly, target of coverage enhancement is primarily for delay tolerant low-cost MTC device which are not mobile. System functionality requirement for large delay tolerant MTC UE requiring enhanced coverage may be relaxed or simplified in comparison to that required by normal LTE UE. HARQ acknowledgement (ACK)/non-acknowledgement (NACK) for PUSCH transmission is carried by physical HARQ indicator channel (PHICH). Dependent on the technique(s) for coverage enhancement PHICH may or may not be required. Control format indicator (CFI) in physical control format indicator channel (PCFICH) is transmitted in each subframe and indicates the number of OFDM symbols used for transmission of control channel information. With some additional complexity in UE (e.g. decoding of control channel assuming different CFI) or higher-layer signaling (e.g. pre-configuration of CFI), PCFICH may be eliminated.

Various concepts for coverage enhancement are described. More energy can be accumulated to enhance coverage by prolonging transmission time. The existing transmission time interval (TTI) bundling and HARQ retransmission in data channel can be helpful. Note that since the current maximum number of UL HARQ retransmission is 28 and TTI bundling is up to 4 consecutive subframes, TTI bundling with larger TTI bundle size may be considered and the maximum number of HARQ retransmissions may be extended to achieve better performance. Other than TTI bundling and HARQ retransmission, repetition can be applied by repeating the same or different redundant version (RV) multiple times. In addition, code spreading in the time domain can also be considered to enhance coverage. MTC traffic packets could be RLC segmented into smaller packets. Very low rate coding, lower modulation order (binary phase shift keying (BPSK)) and shorter length cyclic redundancy check (CRC) may also be used. New decoding techniques (e.g. correlation or reduced search space decoding) can be used to enhance coverage by taking into account the characteristics of the particular channels (e.g., channel periodicity, rate of parameter changes, channel structure, limited content, etc.) and the relaxed performance requirements (e.g. delay tolerance).

More power can be used by the eNB on the DL transmission to a MTC UE (i.e. power boosting), or a given level of power can be concentrated into a reduced bandwidth at the eNB or the UE (i.e. power spectral density (PSD) boosting). The application of power boosting or PSD boosting will depend on the channel or signal under consideration.

The performance requirements for some channels can be relaxed considering the characteristics (e.g. greater delay tolerance) of MTC UEs at extreme scenarios. For the synchronization signal, MTC UEs can accumulate energy by combining primary synchronization signal (PSS) or secondary synchronization signal (SSS) multiple times, but this will prolong acquisition time. For physical random access channel (PRACH), a loosened PRACH detection threshold rate and a higher false alarm rate at eNB could be considered.

New design of channels or signals for better coverage is possible if implementation based schemes cannot meet coverage enhancement requirement. These channels and signals, together with other possible link-level solution for coverage enhancement, are summarized in Table 2.

TABLE 2

| Channels/ | | | | | | |
|---|---|---|---|---|---|---|
| Signals- | | | | | PDSCH/ | |
| Solutions | PSS/SSS | PBCH | PRACH | (E)PDCCH | PUSCH | PUCCH |
| PSD | X | X | X | X | X | |
| boosting | | | | | | |
| Relaxed | X | | X | | | |
| requirement | | | | | | |
| Design new | X | X | X | X | X | |
| channels/ | | | | | | |
| signals | | | | | | |
| Repetition | | X | X | X | X | X |
| Low rate | | X | | X | X | X |
| coding | | | | | | |
| TTI | | | | | X | |
| bundling/ | | | | | | |
| Retrans- | | | | | | |
| mission | | | | | | |
| Spreading | | X | | | X | |
| RS power | | X | | X | X | |
| boosting/ | | | | | | |
| increased | | | | | | |
| RS density | | | | | | |
| New | | X | | | | |
| decoding | | | | | | |
| techniques | | | | | | |

Coverage enhancements using link improvements must be provided for scenarios where no small cells have been deployed by the operator. An operator may deploy traditional coverage improvement solutions using small cells (including pico, femto, remote radio head (RRH), relays, repeaters, etc.) to provide coverage enhancements to MTC and non-MTC UE's alike. In deployments with small cells, the path loss from the device to the closest cell is reduced. As a result, for MTC UEs, the required link budget can be reduced for all channels.

For deployments that already contain small cells, there may be a benefit to further allow decoupled UL and DL for delay tolerant MTC UEs. For UL, the best serving cell is chosen based on the least coupling loss. For DL, due to the large Tx power imbalance (including antenna gains) between the macro and lower power node (LPN), the best serving cell is the one with maximum received signal power. This UL/DL decoupled association is feasible for MTC traffic especially for services without tight delay requirements. To enable UL/DL decoupled operation either in a UE-transparent or non-transparent manner, macro serving cell and potential LPNs may need to exchange information for channel (e.g. RACH, PUSCH, sounding reference signal (SRS)) configurations and to identify the suitable LPN. A different RACH configuration may be needed with decoupled UL/DL, from that without decoupled UL/DL.

Existing solutions that are deployed for coverage enhancement for “normal LTE UE” such as directional antennas, and external antennas can enhance coverage for MTC UE and normal UE alike.

In Rel-13, the low complexity UE is expected to be enhanced with the following objectives.

The provision of Machine-Type Communications (MTC) via cellular networks is proving to be a significant opportunity for new revenue generation for mobile operators. The Rel-12 work item “Low cost & enhanced coverage MTC UE for LTE” specified a low complexity LTE device for MTC with Bill of Material cost approaching that of an EGPRS modem using a combination of complexity reduction techniques. However, results from the study item documented in TR 36.888 indicated that further complexity reduction of LTE devices for MTC can be achieved if additional complexity reduction techniques are supported.

In addition, the study report TR 36.888 concluded that a coverage improvement target of 15-20 dB for both FDD and TDD in comparison to normal LTE footprint could be achieved to support the use cases where MTC devices are deployed in challenging locations, e.g. deep inside buildings, and to compensate for gain loss caused by complexity reduction techniques. The Rel-12 work item “Low cost & enhanced coverage MTC UE for LTE” also made significant progress towards specifying solutions for enhanced coverage but due to time limitations this was removed from the Rel-12 scope. Instead, RAN#63 endorsed a way forward (RP-140512) to continue MTC Coverage enhancements in Rel-13.

Power consumption is another important aspect that deserves more attention. Power saving design is a cross-layer effort, but at the physical layer the known best practice is to reduce active transmit/receive duration to a minimum.

Objective of SI or Core Part WI or Testing Part WI

The general objective is to specify a new UE for MTC operation in LTE that also allows for enhanced coverage compared to existing LTE networks and low power consumption, with the following detailed objectives:

1. Specify a New Rel-13 Low Complexity UE Category/Type for MTC Operation in any LTE duplex mode (full duplex FDD, half duplex FDD, TDD) based on the Rel-12 low complexity UE category/type supporting the following additional capabilities:

i) Reduced UE bandwidth of 1.4 MHz in downlink and uplink
Bandwidth reduced UEs should be able to operate within any system bandwidth.
Frequency multiplexing of bandwidth reduced UEs and non-MTC UEs should be supported.
The UE only needs to support 1.4 MHz RF bandwidth in downlink and uplink
The allowed re-tuning time supported by specification (e.g. ˜0 ms, 1 ms) should be determined by RAN4.

ii) Reduced maximum transmit power.
The maximum transmit power of the new UE power class should be determined by RAN4 and should support an integrated PA implementation.

iii) Reduced support for downlink transmission modes.

iv) The following further UE processing relaxations can also be considered within this work item:
Reduced maximum transport block size for unicast and/or broadcast signaling.
Reduced support for simultaneous reception of multiple transmissions.
Relaxed transmit and/or receive EVM requirement including restricted modulation scheme. Reduced physical control channel processing (e.g. reduced number of blind decoding attempts).
Reduced physical data channel processing (e.g. relaxed downlink HARQ time line or reduced number of HARQ processes).
Reduced support for CQI/CSI reporting modes.

2. Target a relative LTE coverage improvement—corresponding to 15 dB for FDD—for the UE category/type defined above and other UEs operating delay tolerant MTC applications with respect to their respective nominal coverage.

i) The following techniques (which shall be applicable for both FDD and TDD) can be considered to achieve this:
Subframe bundling techniques with HARQ for physical data channels (PDSCH, PUSCH)
Elimination of use of control channels (e.g. PCFICH, PDCCH)
Repetition techniques for control channels (e.g. PBCH, PRACH, (E)PDCCH)
Either elimination or repetition techniques (e.g. PBCH, PHICH, PUCCH)
Uplink PSD boosting with smaller granularity than 1 PRB
Resource allocation using EPDCCH with cross-subframe scheduling and repetition (EPDCCH-less operation can also be considered)
New physical channel formats with repetition for SIB/RAR/Paging
A new SIB for bandwidth reduced and/or coverage enhanced UEs
Increased reference symbol density and frequency hopping techniques
Relaxed “probability of missed detection” for PRACH and initial UE system acquisition time for PSS/SSS/PBCH/SIBs can be considered as long as the UE power consumption impact can be kept on a reasonable level.
The amount of coverage enhancement should be configurable per cell and/or per UE and/or per channel and/or group of channels. Relevant UE measurements and reporting to support this functionality should be defined.

ii) When defining the detailed solutions for the above coverage enhancement techniques, the work should strive to minimize divergence of solutions between the new UE category/type and other UEs. One possible approach is to require a ‘normal complexity UE’ configured with the coverage enhancement techniques to mimic some of the behaviours of a Rel-13 low complexity UE configured with the coverage enhancement techniques.

iii) The work with the physical layer control signaling (e.g. EPDCCH) and higher layer control signaling (e.g. SIB, RAR and Paging messages) should aim for a high level of commonality between the solutions for the new Rel-13 low complexity UEs and the solutions for coverage enhanced UEs.

3. Provide power consumption reduction for the UE category/type defined above, both in normal coverage and enhanced coverage, to target ultra-long battery life:

i) When defining the detailed solutions for the Rel-13 low complexity UEs and the solutions for coverage enhanced UEs, strive to reduce active transmit/receive time. (e.g., minimizing the required number of repetitions by minimizing sizes of control messages).

ii) Modification, including redesign, addition or removal, of signals/channels can be considered if this can achieve significant power consumption reduction.

iii) Reduction of measurement time, measurement reporting, feedback signaling, system information acquisition, and synchronization acquisition time etc., can be considered if this can achieve significant power consumption reduction.

4. Half duplex FDD, full duplex FDD, and TDD should be supported but since half duplex operation is particularly beneficial from device complexity and power consumption point of view, the solutions specified within this work item should be optimized for half duplex FDD and TDD.

5. Reduced mobility support can be considered if this is needed to fulfil the objectives.

The agreements and working assumptions made during the initial work carried out during the corresponding Rel-12 work item should be used as a starting point when applicable.

As an embodiment of the present invention, the UEs using a narrow subband may be considered. For supporting UEs only capable of operating in narrow subband within system bandwidth, there may be multiple subbands for those kind of UEs within system bandwidth. However, it is not clear how the UE and the network determine the subband for the UE.

The present invention comprises of how to determine subband during random access procedure and how to change subband. In general, the UE determines the operating (UL/DL) subband based on its UE identity during random access procedure. The detailed explanation of the invention is as follows.

FIG. 7 shows an example of a method for performing a random access procedure according to an embodiment of the present invention.

Referring FIG. 7, the UE may determine an index of a first subband based on an identity of the UE (S710). In other word, the UE determines the subband for the reception of Msg 4 and subsequent downlink messages and/or the subband for transmission of subsequent uplink messages among multiple subbands based on UE identity. For example, the identity of the UE corresponds to a SAE-temporary mobile subscriber identity (S-TMSI). Or, the identity of the UE corresponds to a random value generated by the UE itself.

As an example, the UE may determine the index of the first subband based on a value corresponding to a remainder after dividing the identity of the UE to a number of subbands within a system bandwidth. In this case, the number of subbands within a system bandwidth may be provided in system information. In addition, the UE may receive information on an available subband for determining the first subband from the network through the system information.

Subsequently, the UE may receive a first message (e.g. Msg 4) for a contention resolution through the first subband from the network (S720). In order to the UE receive a first message through the first subband, the network need to know the identity of the UE. For this, as an example, the UE may transmit a second message (e.g. Msg 3) including the identity of the UE before receiving the first message. In this example, the second message may include a radio resource control (RRC) connection request message or RRC connection reestablishment request message.

By the UE receives a message through the subband determined based on identity of the UE, one embodiment of the present invention may have the effect of distributing the load of the message in the random access procedure.

As an example, the UE need to know information on resources to transmit the second message. For this, the UE may receive a random access response message including information on an uplink grant resource for transmitting the second message through a second subband. The grant information may include subband number. The UE receiving the information on an uplink grant resource may transmit the second message using the uplink resource. At this time, the first subband and the second subband may be different.

As another example, the subsequent uplink and downlink messages may be transmitted/received on the subband determined for receiving a first message.

As an alternative, the Msg 4 provides the subband information for Msg 5 and subsequent uplink message and the subband information for subsequent downlink messages. The network provides the new subband information via PDCCH/MAC CE/RRC reconfiguration message on the current subband. After successfully receiving subband information, the UE transmits/receives using the new subband for the subsequent transmission/reception.

As another alternative, the uplink subband for Msg 5 and subsequent uplink message after sending the first message is determined by the linkage between first subband and uplink subband. In other words, the UE knows the associated uplink subband by acquiring the downlink subband information by pre-configuration or provision via system information. For instance, the same subband index determined for reception of the first message is used to select among the available uplink subbands which is broadcasted by system information.

As another example, if the time offset information (from which the UE should apply the subband information (e.g. SFN information and/or subframe information)) is provided, the UE transmits/receives using the new subband. For example, the subband information may include at least one of uplink and/or downlink subband index, uplink and/or downlink frequency information of the subband, and time offset from which the UE should apply the subband information. The subband described above may be the narrow band within the system bandwidth.

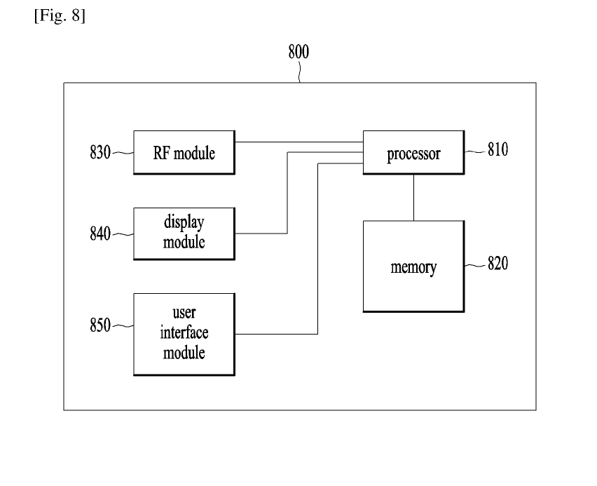

FIG. 8 is a block diagram for one example of a communication device according to one embodiment of the present invention.

Referring to FIG. 8, a communication device 800 includes a processor 810, a memory 820, an RF module 830, a display module 840 and a user interface module 850.

The communication device 800 is illustrated for clarity and convenience of the description and some modules can be omitted. Moreover, the communication device 800 is able to further include at least one necessary module. And, some modules of the communication device 800 can be further divided into sub-modules. The processor 810 is configured to perform operations according to the embodiment of the present invention exemplarily described with reference to the accompanying drawings. In particular, the detailed operations of the processor 810 can refer to the contents described with reference to FIGS. 1 to 7.

The memory 820 is connected to the processor 810 and stores operating systems, applications, program codes, data and the like. The RF module 830 is connected to the processor 810 and performs a function of converting a baseband signal to a radio signal or converting a radio signal to a baseband signal. For this, the RF module 830 performs analog conversion, amplification, filtering and frequency uplink transform or inverse processes thereof. The display module 840 is connected to the processor 810 and displays various kinds of information. The display module 840 can include such a well-known element as LCD (Liquid Crystal Display), LED (Light Emitting Diode), OLED (Organic Light Emitting Diode) and the like, by which the present invention is non-limited. The user interface module 850 is connected to the processor 810 and can include a combination of well-known interfaces including a keypad, a touchscreen and the like.

The above-described embodiments correspond to combination of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. It is apparent that an embodiment can be configured by combining claims, which are not explicitly cited in-between, together without departing from the spirit and scope of ‘what is claimed is’ or that those claims can be included as new claims by revision after filing an application.

In this disclosure, a specific operation explained as performed by a base station can be performed by an upper node of the base station in some cases. In particular, in a network constructed with a plurality of network nodes including a base station, it is apparent that various operations performed for communication with a terminal can be performed by a base station or other network nodes except the base station. In this case, ‘base station’ can be replaced by such a terminology as a fixed station, a Node B, an eNode B (eNB), an access point and the like.

Embodiments of the present invention can be implemented using various means. For instance, embodiments of the present invention can be implemented using hardware, firmware, software and/or any combinations thereof. In case of the implementation by hardware, a method according to one embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention can be applied to a wireless communication system. Specifically, the present invention can be applied to a method and an apparatus performing random access procedure.

1. A method for performing random access procedure by a user equipment (UE) in a wireless communication system, the method comprising:
determining an index of a first subband based on an identity of the UE; and
receiving, from a network, a first message for a contention resolution through the first subband.

2. The method of claim 1, wherein the index of the first subband is determined based on a value corresponding to a remainder after dividing the identity of the UE to a number of subbands within a system bandwidth.

3. The method of claim 2, wherein the number of subbands within the system bandwidth is provided in system information.

4. The method of claim 1, the method further comprising transmitting, to the network, a second message including the identity of the UE before receiving the first message.

5. The method of claim 4, wherein the second message corresponds to a radio resource control (RRC) connection request message.

6. The method of claim 4, the method further comprising receiving, from the network, a random access response message, including information on an uplink grant resource for transmitting the second message, through a second subband.

7. The method of claim 6, wherein the first subband and the second subband are different.

8. The method of claim 1, wherein the identity of the UE corresponds to a SAE-temporary mobile subscriber identity (S-TMSI).

9. The method of claim 1, wherein the identity of the UE corresponds to a random value generated by the UE.

10. The method of claim 1, wherein information on an available subband for determining the first subband is provided in system information.

11. A user equipment (UE) in a wireless communication system, the UE comprising:
a radio frequency (RF) module configured to transmit/receive signals to/from a network; and
a processor connected with the RF module,
wherein the processor is configured to
determine an index of a first subband based on an identity of the UE and
control the RF module to receive, from the network, a first message for a contention resolution through the first subband.

12. The UE of claim 11, wherein the index of the first subband is determined based on a value corresponding to a remainder after dividing the identity of the UE to a number of subbands within a system bandwidth.

13. The UE of claim 12, wherein the number of subbands within the system bandwidth is provided in system information.

14. The UE of claim 11, the processor is further configured to control the RF module to transmit, to the network, a second message including the identity of the UE before receiving the first message.

15. The UE of claim 14, wherein the second message corresponds to a radio resource control (RRC) connection request message.

16. The UE of claim 14, the processor is further configured to control the RF module to receive, from the network, a random access response message, including information on an uplink grant resource for transmitting the second message, through a second subband.

17. The UE of claim 16, wherein the first subband and the second subband are different.

18. The UE of claim 11, wherein the identity of the UE corresponds to a SAE-temporary mobile subscriber identity (S-TMSI).

19. The UE of claim 11, wherein the identity of the UE corresponds to a random value generated by the UE.

20. The UE of claim 11, wherein information on an available subband for determining the first subband is provided in system information.
